(19) United States
(12) Patent Application Publication
(10) Pub. No.: US 2022/0069737 A1
(43) Pub. Date: Mar. 3, 2022

(54) ELECTROSTATIC-ACTUATOR-BASED, TUNABLE, SOFT ROBOTS

(71) Applicant: THE TRUSTEES OF DARTMOUTH COLLEGE, Hanover, NH (US)

(72) Inventors: Congran JIN, White River Junction, VT (US); Zi CHEN, West Lebanon, NH (US); Jinhua ZHANG, Hanover, NH (US); John X.J. ZHANG, Hanover, NH (US)

(21) Appl. No.: 17/298,943

(22) PCT Filed: Nov. 27, 2019
(86) PCT No.: PCT/US2019/063531

§ 371 Date: Jun. 1, 2021

Related U.S. Application Data
(60) Provisional application No. 62/773,009, filed on Nov. 29, 2018.

(51) Int. Cl. H02N 1/00; G05B 19/042; B62D 57/02

(52) U.S. Cl. CPC H02N 1/002; G05B 2219/2603; B62D 57/02; G05B 19/042

(57) ABSTRACT

An electrostatic actuator has a first polymeric layer formed with an arch, a first electrode of metal deposited upon the first polymeric layer; a second polymeric layer formed flat; a second electrode of metal deposited upon the second polymeric layer; and a dielectric disposed on the second electrode. The second polymeric layer is mechanically coupled to the first polymeric layer at a first and second end of the arch. In an embodiment, the actuator has a pair of legs attached to the arch of the first polymeric layer to form a crawler unit. In another embodiment a steerable robot has a first crawling unit with its second polymeric layer mechanically coupled to the second polymeric layer of a second crawling unit.

### CLAIM TO PRIORITY

The present application claims priority to U.S. Provisional Patent Application No. 62/773,009 filed Nov. 29, 2018. The entire contents of the aforementioned application are incorporated herein by reference.

### BACKGROUND

Conventional robots are rigid, powerful and robust, and often used in a variety of activities ranging from manufacturing parts in a streamline to exploring a dangerous place. However, due to their rigid body, they lack flexibility to cope with situations where space is confined, terrain is complex, or the environment changes. Soft robots have been developed that can adapt to different environments. Soft robots made from soft materials with Young's modulus close to that of soft tissues have enhanced flexibility and environmental adaptability compared to rigid robots. They can roughly be classified into either gripping or locomotive robots, which can be further grouped into swimming robots and land based robots. Land based robots can walk, climb, or crawl.

Multiple actuation mechanisms have been developed for soft locomotive robots. For example, pneumatics and hydraulics can easily elongate, contract, bend, twist, and be driven by changes in fluid pressure. A semisoft pneumatic actuator built by slit tubes can be turned into a grasper or a walker. Pneumatically actuated soft robots for pipe inspection inspired by inchworms, and for tube clearing have also been proposed. Pneumatically actuated multigait soft robots that could perform sophisticated locomotion have been proposed with a miniature air compressor. Despite pneumatic being the most popular mechanism for soft robots, shape memory alloy (SMA) and electroactive polymers have also been employed to use temperature and electric fields for actuation, respectively. For instance, worm and caterpillar soft robots developed using SMA are proposed for detection and inspection in narrow spaces. Besides, engineers have fabricated electric, motor, magnetic and even light-driven robots designed to function in limited space or on complex terrain.

Despite the advantages over rigid robots, existing soft robot actuator choices have drawbacks. For example, pneumatic robots usually require complex fluid tunnels or tubes, so they are often heavily tethered and have limited speed as well as efficiency. Despite the great deformation induced by SMAs in response to applied voltage, SMA-based robots require a complex fabrication process, and the thermal cycling necessary to actuate them makes them slow as well. External electromagnetic fields can power untethered robots, but are impractical in many circumstances. The bulky elastomers, gels, and rubbers used to make most soft robots result in most being unsuitable for tasks requiring small or lightweight robots.

Tethered and untethered micro-robots have been proposed for a variety of purposes; for example, they can carry microcameras into active crime scenes so police can plan a way to intervene while remaining small enough to be unnoticed by perpetuators at the scene.

Electrostatic actuation is useful for lightweight and small mechanisms. It has long been utilized for actuation in micro- and nano-electromechanical systems (M/NEMS). Yet current designs that use electrostatic actuation in microrobots suffer from low speed, maneuverability, and adaptability issues.

Electrostatic actuators have been proposed for use in micro-robots. For example, in Untethered Soft Robot Capable of Stable Locomotion Using Soft Electrostatic Actuators, Jiawei Cao, Lei Qin, Jun Liu, Qinyuan Ren, Choon Chiang Foo, Hongqiang Wang, Heow Pueh Lee, Jian Zhu, Extreme Mechanics Letters 21 (2018) 9-16, an actuator is proposed having form of a bent disk of dielectric elastomer that partially flattens when high voltages are applied. Similarly, A Crawler Climbing Robot Integrating Electroadhesion and Electrostatic Actuation, Hongqiang Wang, Akio Yamamoto and Toshiro Higuchi, Int J Adv Robot Syst, 2014, 11:191, proposes an electrostatically-driven belt drive for micro-robots; this belt drive operates by electrostatic attraction and repulsion between conductor stripes on the belt and conductor stripes on a stator.

### SUMMARY

An electrostatic actuator has a first polymeric layer formed with an arch, a first electrode of metal deposited upon the first polymeric layer; a second polymeric layer formed flat; a second electrode of metal deposited upon the second polymeric layer; and a dielectric disposed on the second electrode. The second polymeric layer is mechanically coupled to the first polymeric layer at a first and second end of the arch. In an embodiment, the actuator has a pair of legs attached to the arch of the first polymeric layer to form a crawler unit. In another embodiment a steerable robot has a first crawling unit with its second polymeric layer mechanically coupled to the second polymeric layer of a second crawling unit.

### BRIEF DESCRIPTION OF THE DRAWINGS

FIG. 1 is a schematic cross section of an actuator, in an embodiment.

FIG. 2 is a perspective view of an actuator, in an embodiment, with layer definitions.

FIG. 3A is a schematic view indicating form of the actuator for low voltage differences between the first and second electrode, FIG. 3B for intermediate voltage differences between the electrodes, and FIG. 3C for high voltage differences between the electrodes.

FIG. 3D shows relative displacement developed by 51, and 127 micron thick first polymeric layers in a prototype embodiment.

FIG. 3E is a graph illustrating displacement versus voltage for several depths of initial arch.

FIG. 4A is a schematic cross section of a mobile robot embodiment indicating positions of legs. FIG. 4B is a perspective view of the mobile robot of FIG. 4A.

FIG. 4C is a schematic for explaining trigonometric angles of robot leg motion of the mobile robot of FIG. 4A.

FIGS. 4D, 4E, and 4F are a sequence showing oscillation of actuator-leg joint during motion of the mobile robot of FIG. 4A.

FIG. 4G is an illustration of agreement between the theoretical model of FIG. 4C with experimental results as observed by high speed video.

FIGS. 5A, 5B, and 5C represent stages in a sequence of movements of the mobile robot of FIG. 4A as the robot takes one step.

FIG. 6A illustrates zero-voltage height of the buckled structure.

FIG. 6B illustrates displacement achieved versus frequency of applied voltage.

FIG. 6C illustrates displacement versus applied voltage for thicknesses of 25, 51, and 127 micrometers of the first polymeric layer.

FIG. 6D illustrates displacement versus voltage for various initial buckled heights of the concave structure formed by the first polymeric layer.

FIG. 6E illustrates displacement before and after one million cycles of life testing of an actuator.

FIG. 7A illustrates origami-inspired folds lines for constructing improved legs of paper or polymeric film.

FIG. 7B illustrates folding the folds of the legs of FIG. 7A.

FIG. 7C illustrates legs of FIG. 7A in a stable state SS1 for forward locomotion.

FIG. 7D illustrates legs of FIG. 7A in a stable state SS2 for reverse or backwards locomotion.

FIG. 7E shows the simple cutting pattern on the robot's legs.

FIG. 8 is a perspective view illustrating a steerable micro-robot having two crawling subunits of FIG. 4A, 4B.

FIG. 9 illustrates a robotic system incorporating the micro-robot of FIG. 8.

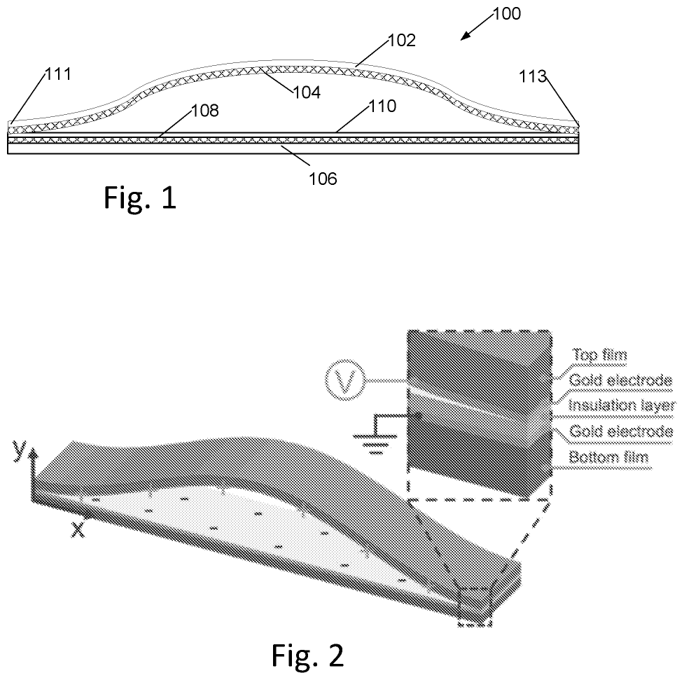

### DETAILED DESCRIPTION OF THE EMBODIMENTS

The electrostatic-actuator based robot we describe herein solves many problems of prior micro-robots, including bulky and heavy body, low speed, slow response, lack of good flexibility/maneuverability, complicated fabrication process and so on. Our robot can survive being crushed: it may be completely compressed until the body becomes flat; then after only a few seconds, its body recovers to original shape and continues moving without loss of mobility.

In an embodiment, the electrostatic actuator 100 of our robot has a first polymeric layer 102. Deposited on first polymeric film layer 102 is a first layer 104 of conductive metal forming a top electrode. In a particular embodiment, the conductive metal of first layer of conductive metal is gold of 10 nanometers thickness, however in other embodiments other conductive metals such as silver or aluminum may be used for conductive metal layer 104. The conductive metal layer should be thin enough to avoid adding undue stiffness to the first polymeric film layer. The actuator also has a second polymeric film layer 106, second polymeric film layer 106 is also coated with a second layer 108 of conductive metal forming a bottom electrode. In a particular embodiment second layer 108 of conductive metal is also a layer of gold, however in other embodiments other conductive metals such as silver or aluminum may be used in place of gold. Atop the second layer 108 of conductive metal is a dielectric insulator layer 110 that serves to prevent contact with the first conductive metal layer. First polymeric film layer 102 is longer than second polymeric film layer 106, and is formed, or buckled, to bulge forming a concave or arched structure. In some embodiments, second polymeric film layer 106 may be significantly more rigid than first polymeric film layer 102. First polymeric film layer 102 is firmly mechanically coupled to the second polymeric film layer at ends 111, 113 of the arch or buckled portion.

In an embodiment, each polymeric film layer and the dielectric insulator layer are polyimide, in particular Kapton films.

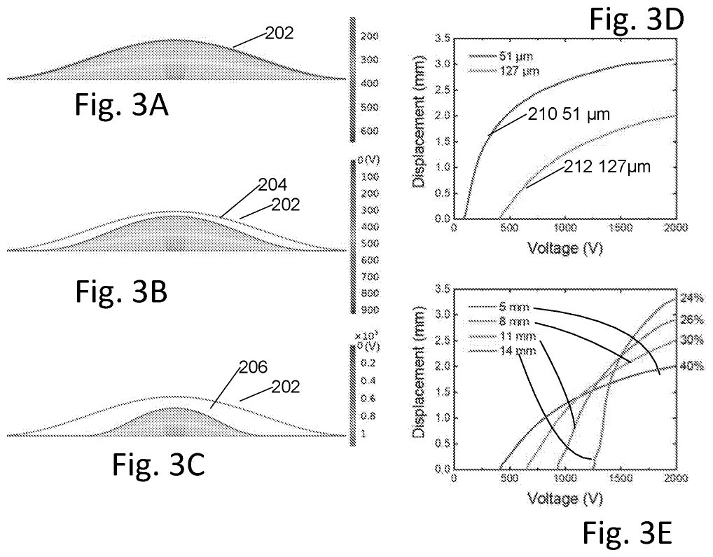

Upon applying a voltage difference between first conductive metal layer 104 and second conductive metal layer 108, there is an attractive force between the layers and first polymeric layer 102 deforms as indicated in FIG. 3A for low voltage, with line 202 indicating the low voltage or original shape of the actuator's first polymeric film layer 102, FIG. 3B for intermediate voltages, where line 204 indicates deformed shape of the actuator's first polymeric film layer, and FIG. 3C where line 206 indicates deformed shape of the actuator's first polymeric layer for high voltage differences. Under an applied voltage, the buckled layer will rapidly deform, in embodiments a voltage-dependent deformation of up to 68% of height, and with the voltage removed, the buckled first polymeric layer returns to its original concave shape. This force has the following qualitative relationship with the input voltage (V) and distance between the top and bottom layer (y):

$${f}_{e} ∝ \frac{{V}^{2}}{{y}^{2}} \qquad ( 1 )$$

Under a constant voltage, the electrostatic force is proportional to

$$\frac{1}{{y}^{2}}$$

and its distribution along the length of the actuator can be visualized as shown in the FIG. 3C: the force is greatest at the ends of the film. This is because the distance y between the top and bottom layer is at its minimum at both ends and maximum in the center as shown in FIG. 3A. During motion, electrical energy is converted to kinetic and elastic energy in the top film. Upon removal of voltage, the electrostatic force vanishes and the deformed top film bounces up, converting elastic energy to kinetic energy. The actuation process was simulated with finite element analysis (FEA) using COMSOL Multiphysics. FIGS. 3A, 3B, and 3C shows the deformation process of the actuator when an increasing voltage is applied. In the simulation, the bottom film is electrically grounded and the voltage gradually increases from 0 to 2000 V as shown by the color contour which represents the voltage field, forcing the top film to be pulled downward.

To quantify the deformation of the top layer in the simulation, we plotted the displacement of the center point of the top layer in response to an increasing voltage. We first compared the deformation performance of devices that have different thicknesses. FIG. 3D shows that a 51 μm-thick top or first polymeric layer 210 undergoes a larger displacement than a 127 μm-hick one 212, which can be explained by the fact that a thinner layer has a lower bending rigidity and therefore bends more significantly when subjected to the same amount of force compared to a thicker one. In embodiments, the first polymeric layer is between 50 and 130 micrometers thick. Also, the thinner film starts to deform at a lower voltage and its displacement increases more rapidly than the thicker one. We then compared the simulated device of different initial buckling heights (i.e. 5, 8, 11 and 14 mm) which is defined as the distance between the tallest point of the top layer and bottom layer before actuation. In FIG. 3E, all devices show a turn-on voltage, below which there is no displacement, and the taller the device, the higher the turn-on voltage. Past this point the displacement rises and it rises more rapidly with taller devices. It was also observed that a taller device has larger deformations at a high voltage (in the range of 1500-2000 V). Moreover, in relative terms, the shorter devices can displace a larger percentage of their overall heights. For instance, at 2000 V, the relative traveling distance (displacement/height) of the top film's center point for devices with height 5, 8, 11 and 14 mm are 40%, 30%, 26% and 24%, respectively, suggesting that the shorter devices more efficiently use their geometry and have larger relative deformation

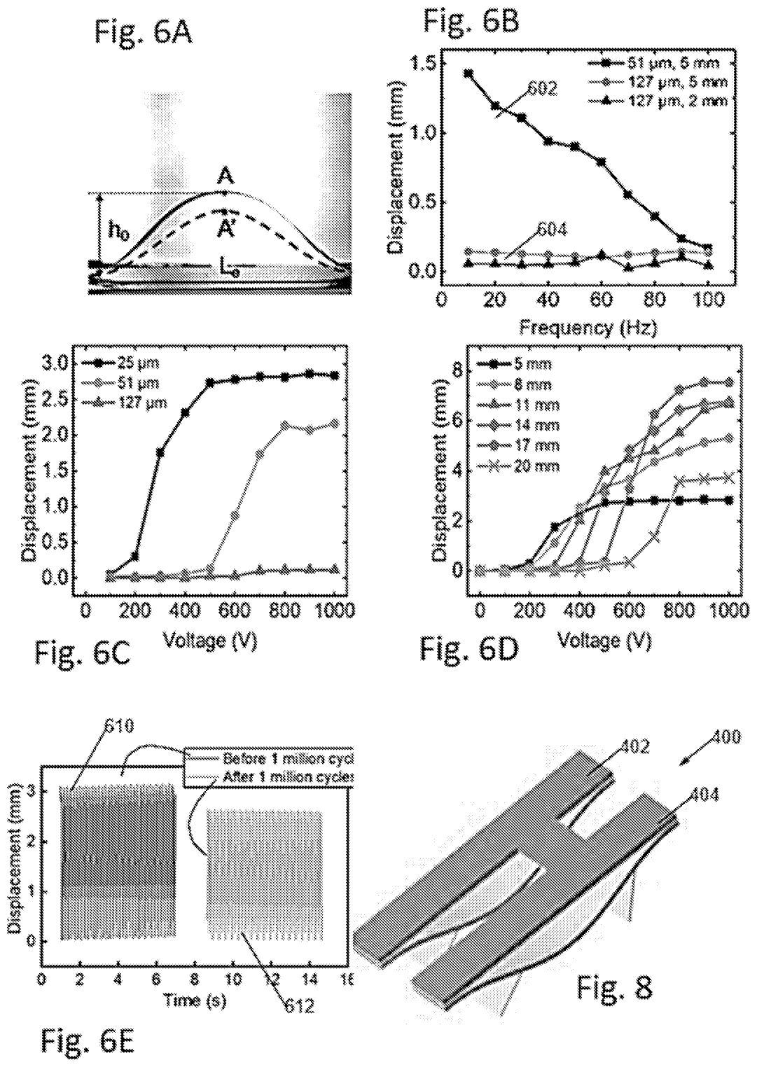

Test results with a 51 μm thick top film 602 and 5 millimeter arch height using sinusoidal voltage excitation show (FIG. 6B) that the displacement dropped from 1.48 mm at 10 Hz to 0.21 mm at 100 Hz with an average slope of −14 μm/Hz. Yet, if the top film is thicker (127 μm) 604, the displacements are much smaller and do not decline significantly over the same frequency range.

To further investigate the role of film thickness and initial buckling height, we measured the displacements of devices with top films of different thicknesses and initial heights at peak voltages from 0 to 500 V, as illustrated in FIG. 3D and FIG. 3E as well as 6A, 6B, 6C, and 6D. As expected, increasing peak voltages always resulted in larger displacements. Greater displacements were obtained from thinner top films. This is because thinner films have a smaller rigidity EI, where E is the Young's modulus and I is the second moment of inertia, which make them easier to bend under the same electrostatic force. Thinner films also deformed at lower voltage thresholds (127 μm film at 350 V, 51 μm at 250 V and 25 μm at 100 V) and had steeper voltage-displacement slopes. For all devices, displacement leveled off after a certain voltage (25 μm film: 2.7 mm at 250 V; 51 μm film: 2.1 mm at 400 V; 127 μm film: 0.1 mm at 350 V). In addition, films with smaller initial heights deformed at lower voltages as shown in FIG. 3E. The maximum displacement (dmax) of top layer also depended on its initial height: it was restricted below 4 mm when the initial height was either too large (e.g. 20 mm) or too small (e.g. 5 mm), because a large initial height reduced the electrostatic force acting on the top film, while a small initial height did not give enough space for large deformation. Only within a middle range (h_0=8 mm-17 mm), larger initial heights cause larger maximum displacements. Lastly, we emphasize that the actuator created large deformation compared to its own size. For heights at 0 volts of 5, 8, 11, 14, 17 and 20 mm, the deformation percentage (defined by maximum displacement divided by height of the actuator or dmax/h0) were 57%, 68%, 61%, 54%, 52% and 30%, respectively.

In a particular embodiment, the actuator is 75 mm long, 10 mm wide, with a 10-mm initial buckled height of the first polymeric layer over the relatively flat second polymeric layer.

In a durability test of one million cycles at 3 Hz of an actuator with 51 millimeter polymeric layer thickness and initial unenergized arch height of 10 millimeters, deflection degraded from an initial deflection of approximately 3 millimeters 610 (FIG. 6E) to about 2.6 millimeters 612.

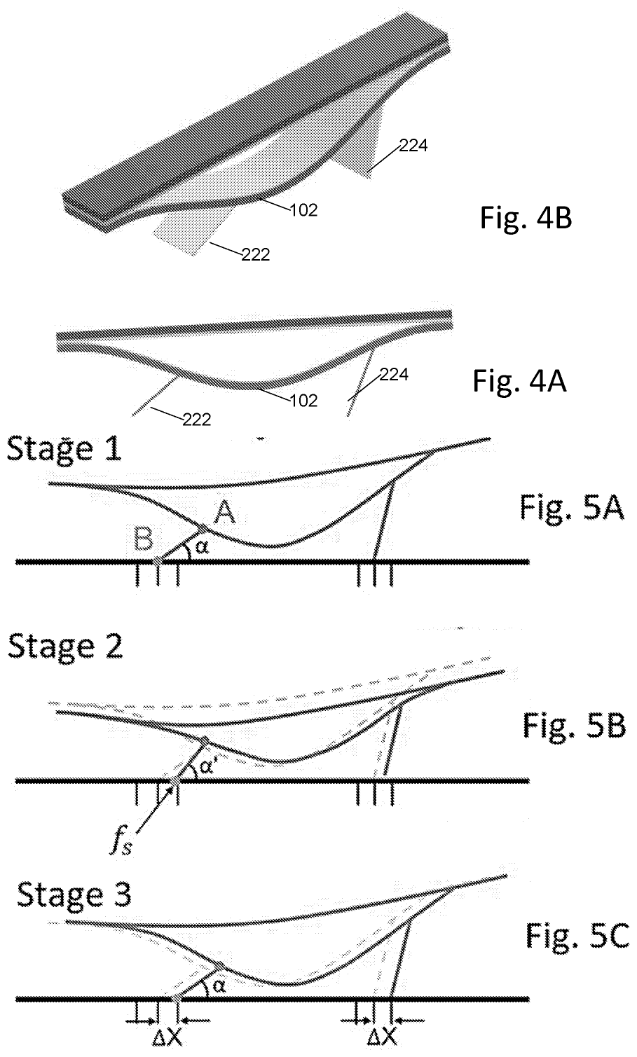

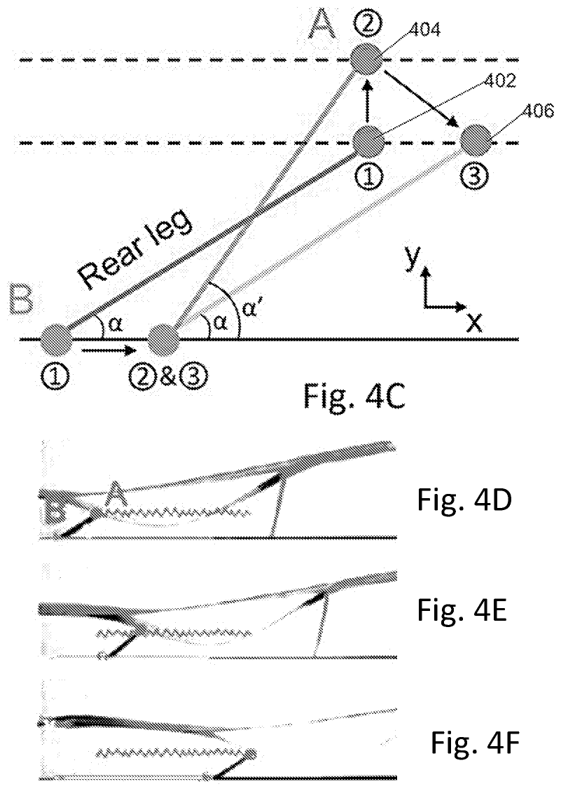

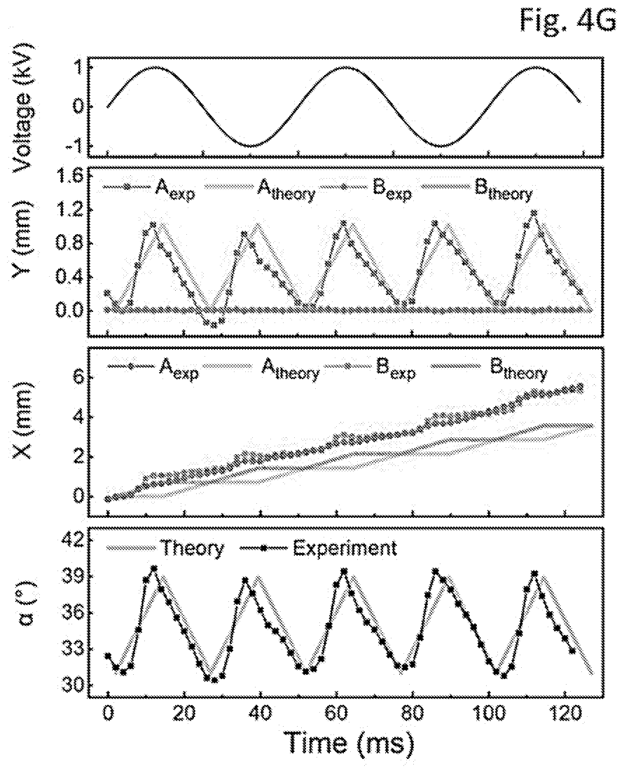

A soft and flexible robot was built using this actuator which showed good locomotive performance and excellent maneuverability. To form a crawling robot, legs 222, 224 are added to the device as illustrated in FIGS. 4A and 4B, the legs being attached to the buckled first polymeric layer 102 with rear leg 222 attached closer to a midpoint of the concave first polymeric layer than is front leg 224. In an embodiment, the legs are formed of paper, and in an alternative embodiment the legs are formed of a polymeric sheet.

Therefore, the moving mechanism of the robot is interpreted using a simple model of the rear leg assuming it is a rigid body as shown in FIG. 4C with the three stages labeled, stage 1 402 (FIG. 5A), stage 2 404 (FIG. 5B), and stage 3 406 (FIG. 5C). To better observe and analyze the detailed locomotion and gait of the robot, we took a slow-motion video of a moving robot, and tracked the path of points A and B, as the robot moves forward. In FIGS. 4D, 4E, and 4F, the wavy path (blue) of point A shows that the belly of the robot is continuously oscillating due to the applied voltage, while the straight path (orange) of point B shows that the rear leg is always moving forward while in contact with the ground. To show how the vertical contraction-expansion of the belly transforms into the horizontal movement of the robot, we plotted the vertical and horizontal displacement of point A and B as well as the angle α over time under a 1 kVp, 20 Hz signal. Theoretical curves are obtained by applying the simple model in FIGS. 4D, 4E, and 4F and solving trigonometrical equations. It is shown that the belly (point A, FIG. 4E) is moving up and down periodically with a displacement of ˜1 mm (FIG. 4G second row) in each period in response to the applied 1 kV peak sinusoidal voltage (FIG. 4G, top row). Point B remains on the ground (without vertical displacement). This vertical movement is transformed into a forward, horizontal motion of the robot which can be represented by the horizontal displacement of both points A and B with the displacement in each period approximately equal to 1 mm as shown in FIG. 4G, third row. Moreover, the angle α (FIG. 4C, FIG. 4G fourth row) between the rear leg and the ground also changes sinusoidally between ˜31° and ˜39° corresponding to the vertical displacement of point A. Overall there is good agreement between the experiments and theoretical predictions, FIG. 4G, third row.

Directional movement results from a difference in the friction coefficient when the legs are moving forwards along the ground versus backwards. Each step of the walking bug micro-robot has three stages. As shown in FIG. 5A, in stage 1, both the top and bottom films are free of electrical charge and thus in their original shapes. Both legs are in contact with the ground. In stage 2, FIG. 5B, as a voltage is applied, the bottom film is pulled up towards the top film. The front leg loses contact with the ground and swings forward, while the rear leg also slides forward. In stage 3, FIG. 5C, upon release of the voltage, the bottom film returns to its original shape and the front leg contacts the ground again. The back leg attempts to slide backwards but is prevented by the higher static friction force in the reverse direction. Both legs move forward a short distance of ΔX during these three stages as seen in FIG. 5C. Sinusoidal AC voltage drives the bug to take many small consecutive steps, resulting in smooth forward motion. Our experiments showed that the rear leg is the dominating leg that drives the robot forward.

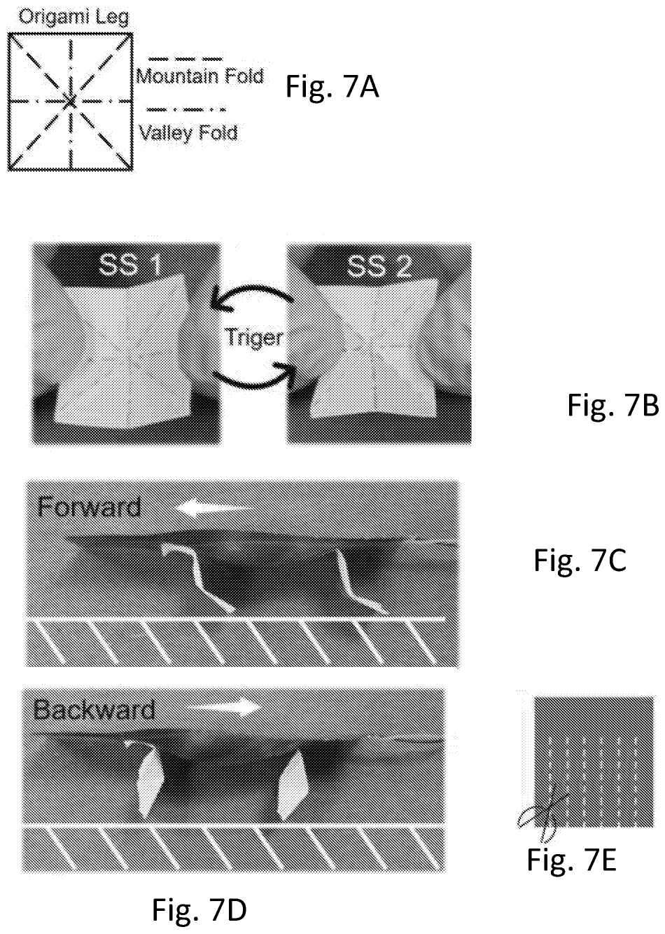

The original legs as heretofore described can be improved by using paper or polyimide films folded with a basic origami fold as illustrated in FIGS. 7A and 7B. By folding the paper following the simplest origami pattern with mountain and valley fold, a bistable paper-based leg is obtained that can be triggered into two mechanically stable states, SS1 and SS2. SS1 (FIG. 7C) tilts the legs forward and SS2 (FIG. 7D) backward driving the robotic bug moves in respective directions. Inspired from Kirigami, where cuts are made on a piece of paper to form aesthetic design in art, we enhanced the robot's mobility through making simple parallel cutting patterns on its legs and body to allow it pass through obstacles and change directions, respectively.

In the obstacle test, it is observed that the robotic bug with the original leg design was inevitably tripped by small obstacles and consequently either detoured or completely stopped. The simple cutting pattern on the robot's legs (FIG. 7E) is to increase the flexibility of the leg as each beam in the leg becomes more vulnerable to bending when hitting the obstacle), and as a result, the robot passed through a series of obstacles with similar sizes. In addition, the robotic bug can thus far only move forwards.

To add maneuverability to it, we cut a simple “H” shape configuration with two legs attached to each of the parallel units, as in FIG. 8. By individually controlling the voltage frequency of each unit, directional control was realized. To test its maneuverability, we challenged the robot to park into a “garage.” It successively accomplished a series of maneuvers including a counterclockwise (CCW) turn, a forward move, a clockwise (CW) turn, another forward move and finally a controlled stop with precision in the “garage” over a distance ˜236 mm in ˜12.5 s. In the process, forward motion and turning maneuvers were achieved by pacing the left and right units independently. In order to simplify the control protocol and to maximize the turning effectiveness, frequencies (left/right) of 20/25 Hz, 0/25 Hz and 20/0 Hz were used for forward motion, CCW turns, and CW turns, respectively, as shown in that provides a kinematic analysis of the “parking” process. Note that the angular velocity when the robot turns can reach up to ˜45°/S (between 0 and 1 second).

A single robotic bug of FIGS. 4A and 4B can only move forwards with its speed controlled by changing the amplitude and frequency of the input voltage. To add maneuverability, we couple a parallel pair of thin-film-based robots 402, 404 (FIG. 8) at second polymeric film layer 106 such that an H shape configuration 400 is obtained. Each of the parallel pair has two folded legs attached. By individually controlling the voltage and frequency of each unit, directional control was realized. A prototype maneuverable embodiment successively accomplished a counter clock-wise (CCW) turn, a forward move, a clock-wise (CW) turn, another forward move and a controlled stop precision over a distance ˜236 mm in ˜12.5 s. Forward motion and turning maneuvers were achieved by pacing the left and right units independently using frequencies of 20-25 Hz for forward motion, and 20-25 Hz on a side moving forwards with a stationary side at 0 Hz for turning movements; it is expected that more gradual turning movements may be accomplished with a full frequency applied to a fast moving side and a lesser, nonzero, frequency applied to a slow moving side.

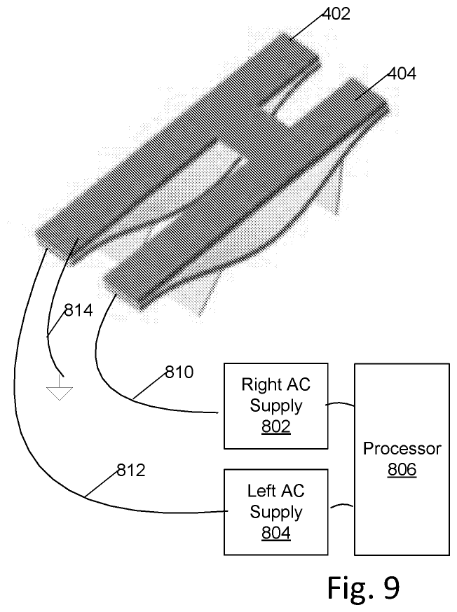

In an embodiment, the maneuverable robot of FIG. 8 has a tether including 3 wires 810, 812, 814 (FIG. 9), one wire 814 is coupled to the second electrode of both sides, one wire 812 to the first electrode of a left side and a left side programmable AC power supply 804, and one wire to the first electrode of a right side 810 and a right side programmable AC power supply 802 of the robot. Both right 802 and left 804 programmable power supplies operate under control of a processor 806 that monitors robot position and orientation with sensors (not shown) and determines appropriate AC signals to be applied through the wires 810, 812 to the electrodes of left and right sides of the robot according to desired movements, including turning and forward movements as necessary to accomplish a mission.

Since the robot is very light weight, to some extent the tethering wires undermines stability of the robot and limits the working range of the robot. We therefore provide a better tethering method and add a body stabilizing mechanism so that the robot has an enhanced stability, and provide for remote operation. To solve the stability problem caused by tethering wires, first, we employ flexible and light weight wires to reduce the dragging force exerted by the wire. Second, we add a posture-correction/adjusting mechanism to the robot. When the robot loses its regular moving posture, the correction mechanism is actuated to help the robot return to its functional posture (e.g. standing posture). Third, in an alternative embodiment, a miniaturized power source including right 802 and left 804 programmable power supplies and processor 806 is equipped on the robot so that it becomes untethered.

Another challenge is for the robot to work in humid conditions in that moistures could cause electrical shorts. Our solution is to deposit a thin layer of insulation polymer onto the electrode surface to prevent electrical shorts resulting from moisture in the air.

When the top electrode is charged positively and the bottom one is connected to ground and fixed in position, the top film is pulled toward the bottom due to the electrostatic force formed across the gap, converting electrical energy to kinetic energy of the motion and elastic energy of the top film. Upon removing electrical charge from the top electrode, the electrostatic force vanishes, and the top film rebounds back up, converting the elastic energy to kinetic energy. Second, we designed a miniature light-weight bug-like soft robot which is developed from the actuator. This robotic bug was fabricated by flipping the actuator upside down with its buckled top film now facing downward, to which two pieces of elastic and foldable sheet (such as paper or polyimide) were attached functioning as its “legs”. When the buckled film (“belly”, as an analogy) periodically deforms due to an applied AC voltage, the two legs move with it simultaneously. The directional movement results from the friction between the robotic bug's legs and the ground (in the direction where legs are tilted to) being smaller than that of the opposite direction. Therefore, the robotic bug moves only in the direction where its legs are tilted toward. The vertical deformation of the actuator has thus been converted to the horizontal motion of the robotic bug. Last, by connecting two single-actuator robotic micro-robots in parallel and individually controlling each unit, an H-shaped electrostatic actuated soft robot with direction control was obtained. The H-shaped robot moves forward, and turns clockwise or counter clockwise depending on the frequency assigned to each unit. This robot is therefore highly controllable and has a good maneuverability.

To operate the H-shaped robotic bug of FIG. 8, one connects the three wires from the H-shaped robot (one ground wire and one each hot wire coupled to the first electrode for each of left side 402 and right side 404) to separate programmable AC supplies 802, 804. Speed and steering of the robot is controlled by either changing the frequency or peak voltage of the AC voltage each side under control of a processor 806.

Summary of Advantageous Results

The actuator creates relatively large (68% of actuator height) and continuous deformations with a quick response. A small (75 mm long) and light weight (<500 mg) robotic bug was built based on the soft actuator moved with controllable speed up to 41 mm/s. In addition, the robotic bug showed (1) climbing ability by going up slopes up to 29°, (2) flexibility via recovering to its original shape and keeping its mobility after being crushed and compressed flat, and (3) adaptability through preserving its mobility on surfaces of different roughness. Finally, by symmetrically coupling two robotic units in parallel, each with legs and actuator, we obtained an H-shaped steerable robot and demonstrated its maneuverability by precisely steering it into a designated space via individually controlling each unit using differences in pulse rates between the two units for steering.

### COMBINATIONS

The actuators and concepts herein described can be combined in several ways. Among ways we contemplate are:

An electrostatic actuator designated A has a first polymeric layer formed with an arch, a first electrode of metal deposited upon the first polymeric layer; a second polymeric layer formed flat, a second electrode of metal deposited upon the second polymeric layer; and a dielectric disposed on the second electrode. The second polymeric layer is mechanically coupled to the first polymeric layer at a first and second end of the arch.

An electrostatic actuator designated AA including the electrostatic actuator designated A wherein the first polymeric layer has thickness between 25 and 130 micrometers, and the arch has an unenergized height between 5 and 20 millimeters.

An electrostatic actuator designated AAA including the electrostatic actuator designated AA wherein the arch has an unenergized height of between 8 and 17 millimeters.

A crawler unit designated AB including the electrostatic actuator designated A, AA, or AAA and at least two legs, the legs attached to the arch of the first polymeric layer.

A crawler unit designated AC including the crawler unit designated AB wherein the legs are polymeric.

A crawler unit designated AD including the crawler unit designated AB wherein the legs are paper.

A steerable robot designated B including a first and a second crawling unit of the type designated AB, AC, or AD, the second polymeric layer of the first crawling unit mechanically coupled to the second polymeric layer of the second crawling unit.

A steerable robot designated BA including the steerable robot designated B further including a first programmable alternating current (AC) supply coupled to the first electrode of the first crawling unit and a second programmable AC supply coupled to the first electrode of the second crawling unit.

Changes may be made in the above system, methods or device without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. An electrostatic actuator comprising:
a first polymeric layer formed with an arch,
a first electrode formed as a layer of metal deposited upon the first polymeric layer;
a second polymeric layer formed flat,
a second electrode formed as a layer of metal deposited upon the second polymeric layer; and
a dielectric disposed on the second electrode;
the second polymeric layer being mechanically coupled to the first polymeric layer at a first end and at a second end of the arch.

2. The electrostatic actuator of claim 1 wherein the first polymeric layer has thickness between 25 and 130 micrometers and the arch has an unenergized height between 5 and 20 millimeters.

3. The electrostatic actuator of claim 2 wherein the arch has unenergized height of between 8 and 17 millimeters.

4. A crawler unit comprising an electrostatic actuator of claim 1 and at least two legs, the legs attached to the arch of the first polymeric layer.

5. The crawler unit of claim 4 wherein the legs are polymeric.

6. The crawler unit of claim 4 wherein the legs are paper.

7. A crawler unit comprising an electrostatic actuator of claim 2 and at least two legs, the legs attached to the arch of the first polymeric layer.

8. The crawler unit of claim 4 wherein the legs are polymeric.

9. The crawler unit of claim 4 wherein the legs are paper.

10. The crawler unit of claim 5 wherein each leg comprises a rectangular portion with two mountain folds and two valley folds.

11. A steerable robot comprising a first and a second crawling unit of claim 3, the second polymeric layer of the first crawling unit mechanically coupled to the second polymeric layer of the second crawling unit.

12. The steerable robot of claim 11 further comprising a first programmable AC supply coupled to the first electrode of the first crawling unit and a second programmable AC supply coupled to the first electrode of the second crawling unit.

13. The steerable robot of claim 12 wherein the first and second polymeric layers are polyimide.

14. The crawler unit of claim 6 wherein each leg comprises a rectangular portion with two mountain folds and two valley folds.

15. The crawler unit of claim 8 wherein each leg comprises a rectangular portion with two mountain folds and two valley folds.

16. The crawler unit of claim 9 wherein each leg comprises a rectangular portion with two mountain folds and two valley folds.

17. A steerable robot comprising a first and a second crawling unit of claim 4 the second polymeric layer of the first crawling unit mechanically coupled to the second polymeric layer of the second crawling unit.

18. A steerable robot comprising a first and a second crawling unit of claim 5 the second polymeric layer of the first crawling unit mechanically coupled to the second polymeric layer of the second crawling unit.

19. A steerable robot comprising a first and a second crawling unit of claim 6 the second polymeric layer of the first crawling unit mechanically coupled to the second polymeric layer of the second crawling unit.
